(19) United States
(12) Patent Application Publication
(10) Pub. No.: US 2010/0263248 A1
(43) Pub. Date: Oct. 21, 2010

(54) Outdoor display Sign

(76) Inventor: Robert Stadjuhar, JR., Colorado Springs, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/729,676

(22) Filed: Mar. 23, 2010

Related U.S. Application Data
(63) Continuation-in-part of application No. 11/605,681, filed on Nov. 28, 2006, now Pat. No. 7,716,861.

(51) Int. Cl. G09F 15/00

(52) U.S. Cl. 40/605

(57) ABSTRACT

An outdoor display sign has a display enclosure. The display enclosure has a number shades that reduce the solar loading on the display enclosure. The outdoor display sign has shades covering the top, back, sides and parts of the front of the sign. The shades are offset from the display enclosure to allow natural airflow between the shade and the display enclosure.

### RELATED APPLICATIONS

The present application is a continuation-in-part and claims priority in U.S. patent application Ser. No. 11/605,681, filed Nov. 28, 2006 assigned to the same assignee as the present application.

### FIELD OF THE INVENTION

The present invention relates generally to the field of signs and more particularly to an outdoor display sign.

### BACKGROUND OF THE INVENTION

Outdoor variable message signs are used to provide information to motorists. One example of these signs are the variable message signs used by highway departments to tell motorists, what lanes are open and short messages such as accident ahead. It is the goal of highway departments to provide motorist with more information on the state of the highway ahead. Variable message signs require controllers, drivers, and a number of environmental control systems. These environmental control systems include filters that have to be replaced, fans to blow air through the sign and in some cases air conditioners. This increases the cost of variable message signs and limits the number of places that these signs are utilized.

Thus there exists a need for a simpler, less expensive outdoor variable message sign.

### SUMMARY OF INVENTION

An outdoor display sign that overcomes these and other problems has a display enclosure. The display enclosure has a number shades that reduce the solar loading on the display enclosure. The outdoor display sign has shades covering the top, back, sides and parts of the front of the sign. The shades may be offset from the display enclosure to allow natural airflow between the shade and the display enclosure. In one embodiment, the display enclosure is completely sealed and does not have any environmental control equipment. This is because the shades provide adequate shading of the sun so that no environmental control equipment is required. Occasionally, the sealed display enclosure has a detached controller and/or power supplies. In one embodiment, the display enclosures are modular and may be used to operate and maintain a larger sign out of a number of one line modules. The sign may have a mask that provides contrast enhancement for the display and provides additional protection from solar loading when the sun is low in the sky.

### BRIEF DESCRIPTION OF THE DRAWINGS

FIG. 1 is a perspective drawing of an outdoor display sign in use on a highway in accordance with one embodiment of the invention;

FIG. 2 is a side view of an outdoor display sign in accordance with one embodiment of the invention;

FIG. 3 is a cross section of an outdoor display sign in accordance with one embodiment of the invention;

FIG. 4 is a perspective view of a display enclosure in accordance with one embodiment of the invention;

FIG. 5 is a perspective view of the modular nature of a display enclosure in accordance with one embodiment of the invention;

FIG. 6 is a cross section of an outdoor display sign in accordance with one embodiment of the invention;

FIG. 7 is a cross section of a display enclosure showing a mask in accordance with one embodiment of the invention;

FIG. 8 is a perspective view of an outdoor display sign in accordance with one embodiment of the invention;

FIG. 9 is a side view of a modular sign system in accordance with one embodiment of the invention;

FIG. 10 is an exploded perspective view of an outdoor display sign in accordance with one embodiment of the invention;

FIG. 11 is a front view of a modular sign system in accordance with one embodiment of the invention; and

FIG. 12 is a front view of a modular sign system in accordance with one embodiment of the invention.

### DETAILED DESCRIPTION OF THE DRAWINGS

The present invention is directed to an outdoor variable message display sign that is inexpensive to build and maintain. A key to building an inexpensive variable message sign was to eliminate the need for an active cooling system. These outdoor variable message signs use LEDs (Light Emitting Diodes) or other electrical/electronic light sources. When these light sources and their associated electronics get too hot it reduces their lifetime. The outdoor variable message display sign described herein keeps the electronics cool using a passive system of shades. The electronics and lights are placed in a display enclosure. The display enclosure has shades that block the light from hitting the top, back, sides and front of the display enclosure. The shade facing north may be eliminated because the sun will not shine on the north side of the sign in the northern hemisphere. Of course the opposite is true in the southern hemisphere. Since the sun's solar loading is the biggest factor effecting the internal temperature of a sign, using the shades allows a display to have no active cooling or at least significantly reduces the cooling system requirements. The structure to hold the shades may be designed so that air may freely travel between the display enclosure and the shades. This allows natural breezes to cool the display enclosure and associated electronics and allows for natural convention to pull cool air past the display enclosure. As a result, of this passive cooling system the outdoor display sign is easier and less expensive to operate and maintain than actively cooled signs. In addition, the sign may have a mask that provides contrast enhancement for the display and provides additional protection from solar loading when the sun is low in the sky.

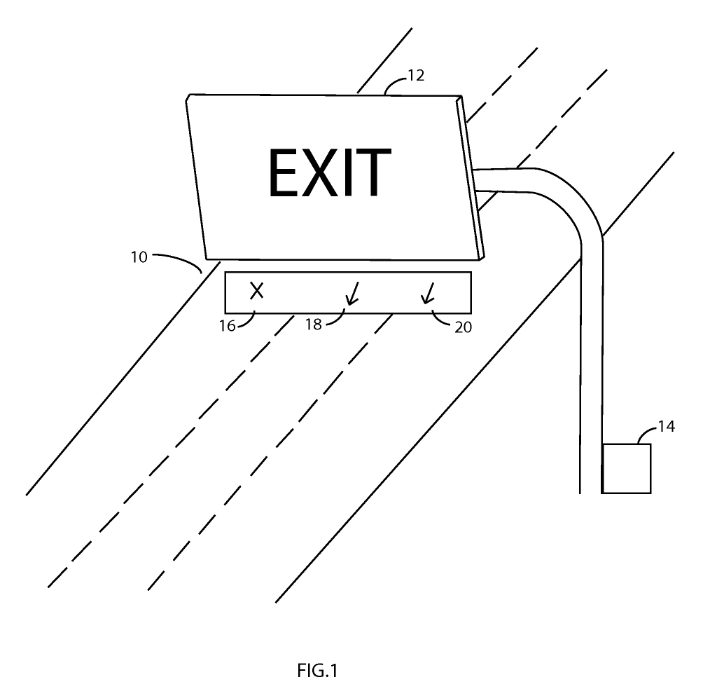

FIG. 1 is a perspective drawing of an outdoor display sign 10 in use on a highway in accordance with one embodiment of the invention. The sign 10 in this case is mounted below a standard static highway sign 12. The outdoor display sign 10 has a controller 14 which may be pole mounted or may be on the ground. The controller 14 is in communication with the sign 10 and directs the sign to display various messages 16, 18, 20. In this case the sign 10 is a one line sign and is just displaying an “X” 16 for a closed lane and an arrow 18 & 20 for an open lane.

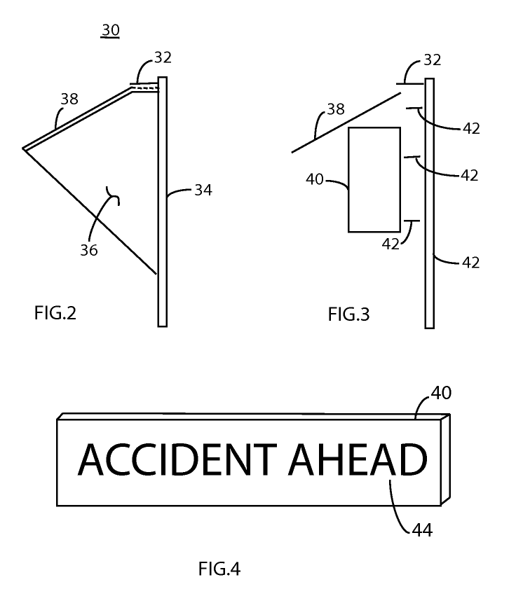

FIG. 2 is a side view of an outdoor display sign 30 in accordance with one embodiment of the invention. It is important to note that the invention is directed to electronic signs where cooling is an issue due to solar loading. This view shows that the sign enclosure (shown in FIG. 3) is shaded by a top shade 32, back shade 34, side shade 36 and front shade 38. The shades 32, 34, 36, 38 form a shade system that block direct sunlight from impinging on the display enclosure except on the face of the display enclosure when the sun is low in the sky. “Low in the sky” can be defined as only 25 degrees above the horizon or lower.

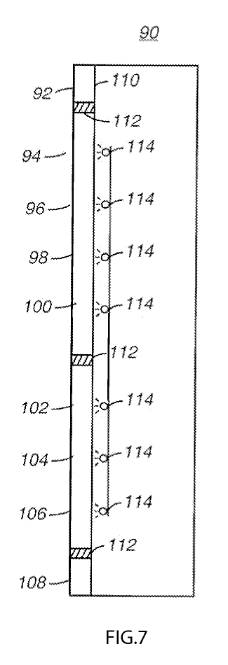

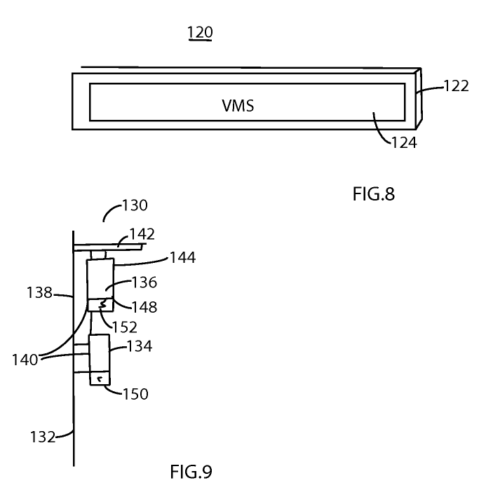

FIG. 3 is a cross section of an outdoor display sign 30 in accordance with one embodiment of the invention. The sign 30 contains a display enclosure 40. The display enclosure 40 holds the electronic/electric light sources and associated drive electronics. In one embodiment, the display enclosure 40 is completely sealed. This means that essentially no air or water enters or leaves the display enclosure 40. In addition, it means that the light sources are enclosed in the display enclosure. In one embodiment, the display enclosure 40 has a transparent glazing in front of the light sources. A mask (see FIG. 7) may be used to further reduce the solar loading when the sun is low in the sky and impinging on the front of the sign. The display enclosure 40 is mounted to a back mounting plate 34, which acts as a back shade. The support members 42 are shown as dashed lines. The support members 42 do not significantly impede the airflow between the back of the display enclosure 32 and the mounting plate 34. A top shade 32 is mounted to the mounting plate 34. The top shade 32 is offset from the top of the display enclosure 40 and keeps the sunlight from directly hitting the top of the display enclosure 40. A display shade 38 is offset from the display enclosure 40 and is coupled to the mounting plate 34 by supports 42. Again the supports do not extend the length of the display enclosure 40 and therefore do not impede the airflow between the shades 32, 34, 38 and display enclosure 40 or between the display enclosure 40 and the mounting plate 34. Note that the display shade 38 is sloping instead of horizontal to shed snow. In environments that do not have snow, the front shade 38 may be horizontal instead of sloping.

FIG. 4 is a perspective view of a display enclosure 40 in accordance with one embodiment of the invention. In this case the display enclosure 40 is a single line display. Commonly, the display enclosure 40 has a plurality of LEDs (Light Emitting Diodes) that are used to form the display “Accident Ahead” 44. Note that the display 44 is considered the front of the display enclosure. In one embodiment, the display enclosure 40 is sealed. This means that the display enclosure 40 does not allow exchange of water, dirt or air between the interior of the enclosure and the exterior of the enclosure.

FIG. 5 is a perspective view of the modular nature of a display enclosure in accordance with one embodiment of the invention. A pair of display enclosures 50 & 52 are placed next to each other to form a coherent single display 54. Each of the display enclosures 50 & 52 are controlled by a single controller to form the display “ICE ON ROAD.” Note that the display enclosure can also be placed side by side to form a long horizontal sign.

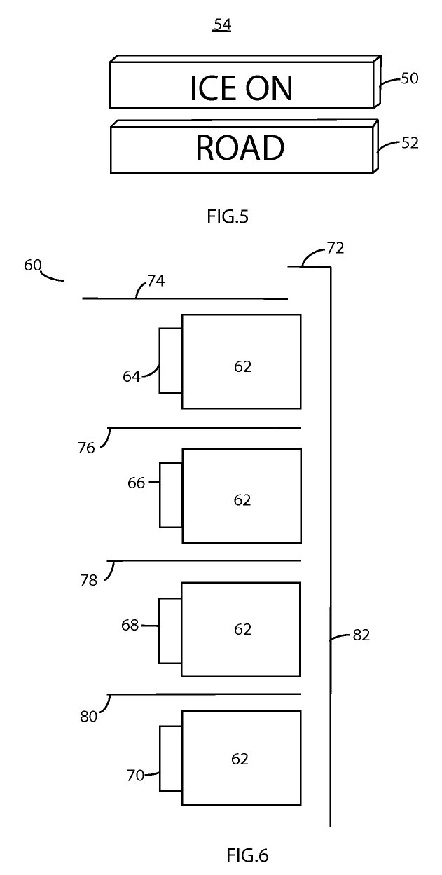

FIG. 6 is a side view of an outdoor display sign 60 in accordance with one embodiment of the invention. This sign 60 is a multi-line display. The multi-line display 60 has a plurality of display enclosures 62 each having line 64, 66, 68, 70 of display. The sign 60 has a top shade 72 and a number of display shades 74, 76, 78, 80 and has a back shade 82. Note that the display sign 60 may also have side shades similar to that shown in FIG. 2. The display shades 76, 78, 80 are positioned between the display lines 64, 66, 68, 70 of the display. The shades 72, 74, 76, 78, 80 are offset from the display enclosure 62 and held in place by structural supports. This shading reduces or eliminates the need for active cooling systems.

Computer simulations have shown that the single line variable message display sign similar to the one in FIGS. 2 & 3 will actually have lower temperatures for the control electronics in most cases than actively cooled signs.

FIG. 7 is a cross section of a display enclosure 90 showing a mask 92 in accordance with one embodiment of the invention. The mask 92 has a number of holes 94, 96, 98, 100, 102, 104, 106 that are generally circular. The front 108 of the mask 92 is a mat black which enhances the contrast ratio of the sign 90. The mask 92 is held to a glazing 110 by insulating foam adhesive strips 112. The adhesive strips 112 hold the mask 92 offset from the glazing 110. As a result, air can flow between the holes 94, 96, 98, 100 and 102, 104, 106. The air flow between the holes helps to keep the sign enclosure 90 cool. In addition, the offset prevents thermal conduction from the mask to the glazing 110. The holes 94, 96, 98, 100, 102, 104, 106 are aligned with the display elements 114. Thus, there has been described an outdoor variable message sign that provides maximum protection from solar loading. As a result, the sign enclosure generally does not require active cooling systems.

FIG. 8 is a perspective view of an outdoor display sign 120 in accordance with one embodiment of the invention. The sign 120 has a housing 122 that has a parallelpiped shape. A variable message display (VMS) 124 forms a face of the housing. The sign 120 does not have an active cooling or other environmental controls.

FIG. 9 is a side view of a modular sign system 130 in accordance with one embodiment of the invention. The sign system 130 has a mounting system 132 that may be permanently embedded in a foundation or may be attached to a bridge or other structure. The system 130 has a pair of housings 134, 136 each of which have a variable message display. The housings 134, 136 are offset from and held by the mounting system 132. The reason the housings 134, 136 are offset is to allow air flow between the mounting system 132 and the housing 134, 136. In one embodiment, the mounting system 132 includes a back shade 138 that prevents sunlight from impinging on a back side 140 of the housings 134, 136. A shade 142 is attached to the mounting system 132 and is offset from a top 144 of the housing 136 and covers the top 144 and prevents sun from impinging on the top 144 of the housing 136. In one embodiment, the shade 142 extends beyond a front face 148 of the housing.

The housings 134, 136 form sign modules. In this case the module 134 has a controller 150 and the module 136 acts as the slave 152. In another embodiment, the controller 150 may be separate from both modules 134, 136. The modules 134, 136 can function as two separate signs or they can function a single virtual sign. A virtual sign means that two modules 134, 136 function as a single sign even though they are physically separate housings.

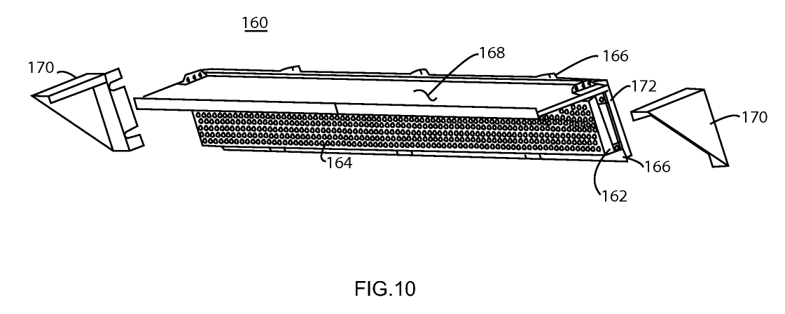

FIG. 10 is an exploded perspective view of an outdoor display sign 160 in accordance with one embodiment of the invention. The sign 160 has a housing 162 having a face with a variable message display 164. The housing 162 is mounted to a mounting structure 166. A top shade 168 is attached to the mounting system 166 and offset from a top of the housing 162. A pair of side shades 170 attach to the mounting system 166 are offset from the housing 162 and keep the sun from impinging the sides of the sign housing 162. The shades 170 are offset from the housing 162 to allow airflow between the housing 162 and the shades 168, 170. In one embodiment, a back shade 172 is attached to the mounting system 166 and offset from the housing 162. The back shade 172 prevents sun from impinging on the backside of the housing 162. The housings 162 may be stacked vertically or horizontally.

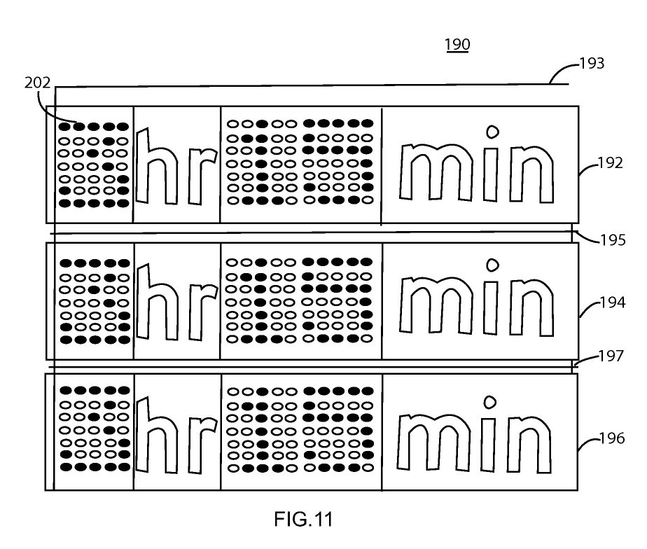

FIG. 11 is a front view of a modular sign system 190 in accordance with one embodiment of the invention. The modular sign system 190 is made up of three housings 192, 194, 196 stacked vertically. A display shade 193, 195, 197 is provided for the housings 192, 194, 196. Each of the housings 192, 194, 196 has a variable message display 198, 200, 202. One of the housings acts as the master and the other housings act as slaves. This modular design can be used to create one large virtual sign or operate as three separate signs.

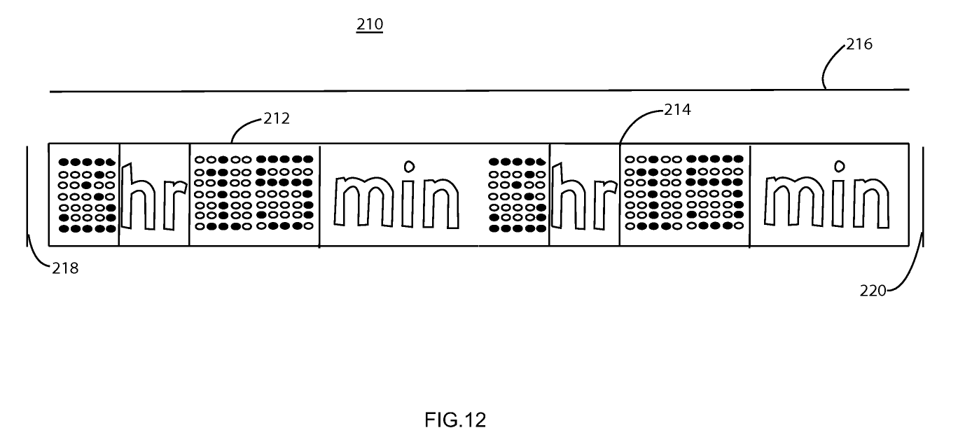

FIG. 12 is a front view of a modular sign system 210 in accordance with one embodiment of the invention. This system 210 has a pair of housing 212, 214 mounted horizontally. A shade 210 covers the top of the housings and a pair of side shades 218, 220 may also be provided. Generally one of the housings will be the master and the other the slave.

Thus there has been described a modular sign system that uses shades so that it does not require an active cooling system. The modules can be combined to form a virtual sign or function as separate signs. The modules may be mounted vertically or horizontally. Since the modules do not require active environmental system, they require significantly less maintenance than traditional variable message signs. The modular design provides flexibility and reduces the cost of custom sized signs.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A modular sign system having a variable message sign and a passive heat shielding system, comprising:
a plurality of sign modules, each of the sign modules have a variable message display, each of the plurality of sign modules having a housing;
a mounting system;
a controller transmitting a display message to at least one of the plurality of sign modules; and
a shade offset from a top of the housing of at least one of the plurality of sign modules, wherein the shade reduces solar loading so that the plurality of sign modules do not need any active environmental controls.

2. The system of claim 1, wherein the plurality of sign modules are mounted horizontally.

3. The system of claim 1, wherein the plurality of sign modules are mounted vertically.

4. The system of claim 1, wherein the plurality of sign modules form a virtual sign.

5. The system of claim 1, wherein the shade extends beyond a face of the at least one of the plurality of sign modules.

6. The system of claim 1, wherein the housings of the plurality of sign modules are sealed

7. An outdoor display sign, comprising:
a housing having a rectangular prism shape;
a variable message display forming a part of a face of the housing;
a controller transmitting a display message to the variable message display; and
a shade offset from a top of the housing of at least one of the plurality of sign modules, wherein the shade reduces solar loading so that the plurality of sign modules do not need any active environmental controls.

8. The sign of claim 7, further including a back shade offset from the housing.

9. The sign of claim 7, further including a side shade offset from the housing.

10. The sign of claim 7, wherein the housing is mounted to a permanent structure.

11. A modular sign system, comprising:
a plurality of housings each having a parallelepiped shape;
a plurality of variable message displays, one for each of the plurality of housings, each of the plurality of variable message displays forming a face of one of the plurality of housing;
a mounting system; and
a controller transmitting a display message to at least one of the plurality of variable message display.

12. The system of claim 11, further including a shade offset from a top of one the plurality of housings and covering a top side of the one of the plurality of housings so that the plurality of housings do not need any active environmental controls.

13. The system of claim 12, wherein the plurality of variable message displays form a virtual sign.

14. The system of claim 12, wherein the plurality of sign modules are mounted horizontally.

15. The system of claim 12, wherein the plurality of sign modules are mounted vertically.

16. The sign of claim 12, further including a back shade offset from the housing.

17. The sign of claim 12, further including a side shade offset from the housing.

18. The sign of claim 12, wherein the mounting structure is attached to a permanent structure.
